(19) United States
(12) Patent Application Publication
(10) Pub. No.: US 2014/0184520 A1
(43) Pub. Date: Jul. 3, 2014

(54) Remote Touch with Visual Feedback

(71) Applicant: MOTOROLA MOBILITY LLC, Libertyville, IL (US)

(72) Inventors: Wen Hao Zhang, Lake Villa, IL (US); Rong Cai, Nanjing (CN); Long Ling, Nanjing Jiangsu (CN); Andrew K. Wells, Lindenhurst, IL (US)

(73) Assignee: Motorola Mobility LLC, Libertyville, IL (US)

(21) Appl. No.: 13/729,426

(22) Filed: Dec. 28, 2012

(51) Int. Cl. G06F 3/00

(52) U.S. Cl. CPC G06F 3/005
USPC 345/173

(57) ABSTRACT

An electronic device (106), and methods thereof, for managing displayed content is disclosed herein. A graphic image is provided at a surface of a touch screen. A photographic image is received at a photographic sensor (102) distal from the surface of the touch screen. The photographic image includes a first photographic fragment of at least a part of an object (108) obscuring a portion of the graphic image and a second photographic fragment of a remainder of the graphic image that is unobscured by the at least a part of the object (108). For one embodiment, the first photographic fragment is transmitted to a display screen (110) distinct from the touch screen and is superimposed over a portion of the graphic image provided at the surface of the touch screen. For another embodiment, a graphic fragment corresponding to the second photographic fragment is transmitted to the display screen (110) and superimposed over the photographic image.

### FIELD OF THE DISCLOSURE

The present disclosure relates generally to a visual feedback and more particularly to remote touch with visual feedback.

### BACKGROUND

Recently, multi-touch technologies are emerging for application in providing visual feedback to a user of a multi-touch device. Generally, the user of the multi-touch device provides an input to the multi-touch device and a display screen, distant from the multi-touch device, provides a visual feedback to the user. The visual feedback displays an animated version of an object an animated version of the user's hands or a stylus placed over the multi-touch device. In this manner, a user is provided with the user experience of using a distant touch screen display device without having to physically touch the display device.

For example, Tactiva's Tactapad captures continually captures an image of a user's hands and then, overlays an animated image of the user's hands on a display as live video. As another example, Panasonic Corporation's EZ Touch remote control provides an animated visual feedback on a display of a user's hand placed on the EZ Touch remote control. Further, US 2011/0063224 A1 publication provides a virtual representation of a user's thumbs on a display that is distant relative to the user.

All the above technologies, and other conventional technologies, provide a virtual or animated representation of an object as a visual feedback to the user.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an electronic device and a display screen in accordance with some embodiments.

FIG. 2(a) is a perspective view of the electronic device of FIG. 1 and a camera associated with the electronic device in accordance with some embodiments.

FIG. 2(b) is a perspective view of the camera of FIG. 2(a) in accordance with some embodiments.

FIG. 3 is a block diagram of the electronic device, a remote touch receiver, and a display screen in accordance with some embodiments.

FIG. 4 is a flowchart of a first method in accordance with some embodiments.

FIG. 5 is a flowchart of a second method in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail the particular method and system for a remote touch with visual feedback, in accordance with an embodiment of the present disclosure, it should be observed that the present disclosure resides primarily in combinations of method steps and apparatus components related to the method and system for a remote touch with visual feedback. Accordingly, the apparatus components and method steps have been represented where appropriate by conventional symbols in the drawings, showing only those specific details that are pertinent to understanding the present disclosure, so as not to obscure the disclosure with details that will be readily apparent to those of ordinary skill in the art, having the benefit of the description herein.

A method of an electronic device, such as a touch control pad, for displaying content is disclosed herewith. The method includes providing a graphic image at a surface of the electronic device 106. The method further includes receiving, at a photographic sensor distal from the surface of the electronic device 106, a photographic image including a first photographic fragment of at least a part of an object obscuring a portion of the graphic image and a second photographic fragment of a remainder of the graphic image that is unobscured by the at least a part of the object. The method further includes transmitting, to a display screen distinct from the electronic device 106, the first photographic fragment of the at least a part of the object superimposed over a portion of the graphic image provided at the surface of the electronic device 106.

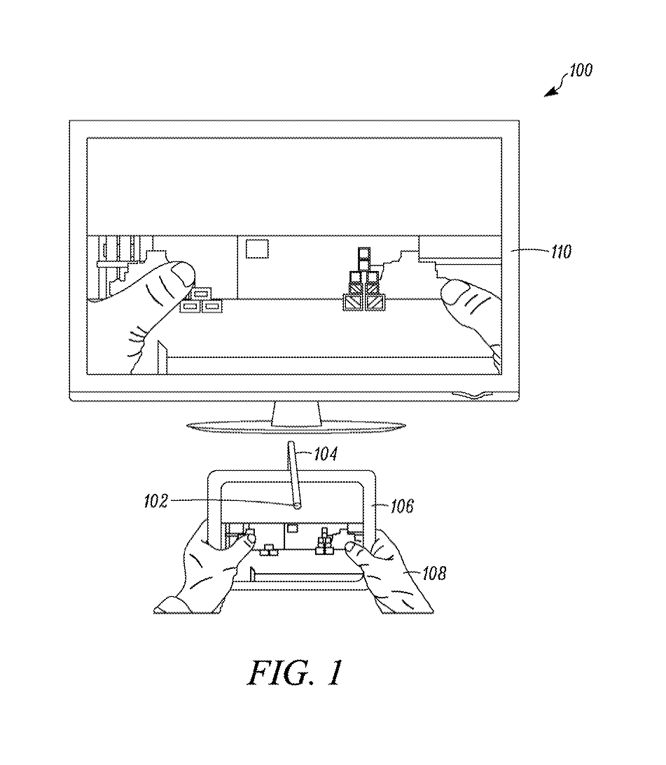

FIG. 1 is a perspective view 100 that represents various entities such as a camera 102, a camera support 104, an electronic device 106, an object 108, and a display screen 110 in accordance with an embodiment of the invention. In accordance with the embodiment of the invention, the electronic device 106 may be a touch-sensitive wireless communication device such as a mobile device, a cellular or mobile phone, a messaging device, a mobile data terminal, a mobile station, user equipment, a smart phone, a battery-powered device, a wearable device, a computer (laptop, desktop, hand-held, etc.), a personal digital assistant (with or without a wireless connection), a netbook, a gaming console, a portable computing device, touch controller, touch control pad, an e-reader, an e-book, a tablet device, a navigation device with a video capable screen, a multimedia docking station, or a similar mobile or computing device. The electronic device 106 may display a real-time or non real-time graphic image or video.

In accordance with the embodiment of the present invention, the object 108 may comprise a user's hand, a stylus, a digital pen, a digital pencil, or any of the wide variety of devices that may be implemented for use of a touch-sensitive device such as the electronic device 106. The object 108 can be placed stationary, swiped horizontally or vertically, dragged over, or moved over the electronic device 106 in any direction by making a contact with the surface of the electronic device 106. In one embodiment, the surface of the electronic device 106 may be a touch screen. In this manner, the electronic device 106 may detect a position, a change in position, or any type of movement made by the object 108 over the surface of the electronic device 106. The electronic device 106 may further carry out subsequent operations based on the detected movement of the object 108 on the surface of the electronic device 106.

Further, the display screen 110 may be implemented as a display device. The display screen 110 may display various images or objects, such as a set of icons. The display screen 110 may be implemented as a remote display device relative to the electronic device 106. The display screen 110 may further communicate with any device described herein such as the electronic device 106. The display screen 110 may receive signals from the electronic device 106 and provide visual feedback such as displaying an actual real-time image of the object 108 superimposed over a graphic image that is displayed at the electronic device 106.

For example, a user of the electronic device 106 is playing a game, on the electronic device 106. If the user desires to view the game on a larger display such as that of the display screen 110, it may be challenging for the user to repeatedly look down at the electronic device 106 for providing inputs while game is being continually watched on the display screen 110. However, in accordance with the present invention, the display screen 110 provides an actual real-time visual feedback of the user's hands as placed over the electronic device 106 at the display screen 110. The user can use the electronic device 106 to input touch events and see an actual real-time visual image of the user's hands on the display screen 110 while playing the game. In this manner, the user does not have to look at the electronic device 106 while the user is playing. The actual real-time visual feedback at the display screen 110 provides the user, an experience equivalent to playing and viewing the game on a electronic device 106 but with a larger display as that of the display screen 110.

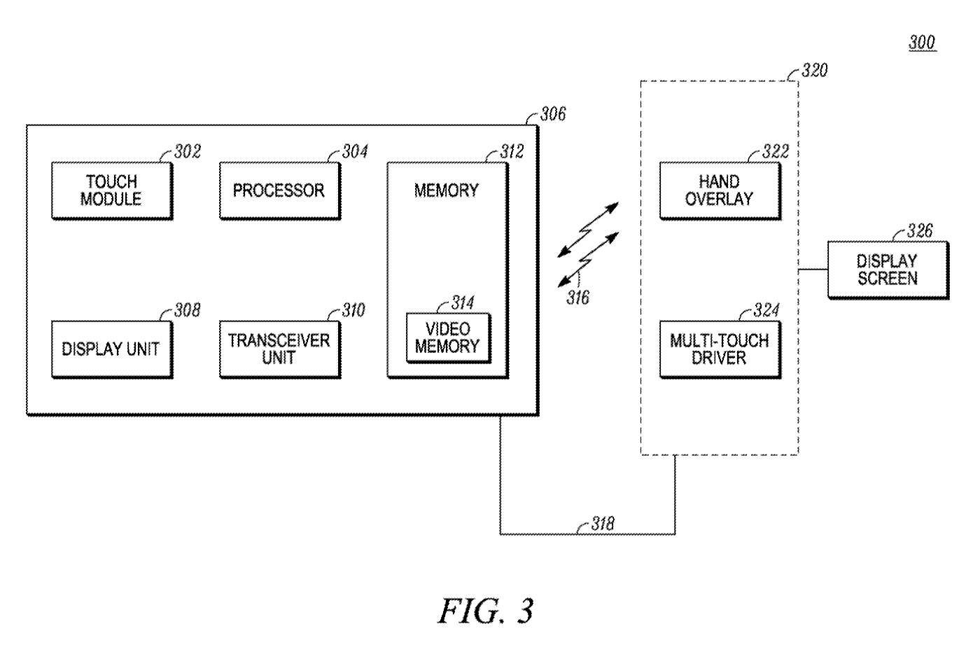

The details of the internal components of the display screen 110 will be provided along with the description of FIG. 3.

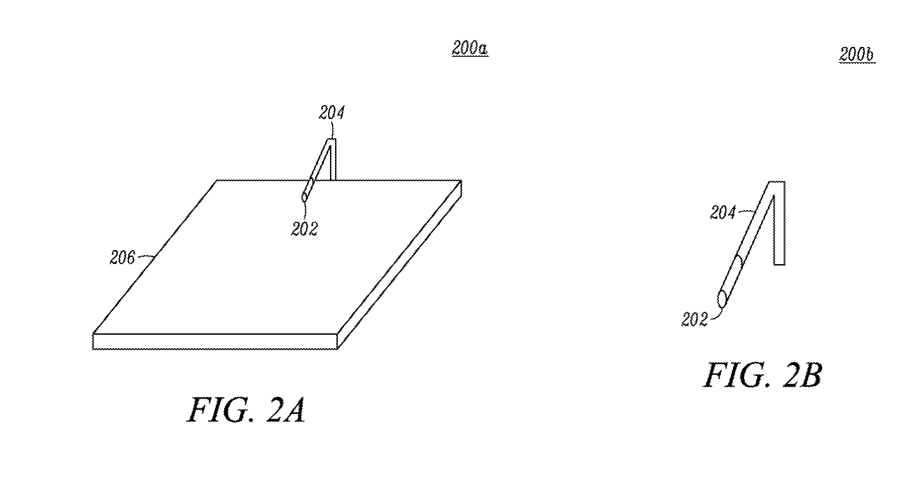

Further, the camera 102 and the camera support 104 correspond to a camera 202 and a camera support 204, respectively of FIG. 2. The details of the camera 202 and the camera support 204 will be described along with the description of FIG. 2.

Moreover, it is to be understood that FIG. 1 is provided merely for the purpose of illustrating the principles of the present invention. FIG. 1 is not intended to be a comprehensive perspective view of all of the components of such a communication system. Therefore, the system 100 may comprise various other configurations and still be within the scope of the present disclosure.

FIG. 2 depicts a perspective view of a camera 202, a camera support 204, and an electronic device 206. In accordance with an embodiment of the invention, the camera 202 may be implemented as any type of camera such that it is capable of capturing a still image or a video in real-time. The camera 202 may be selected from a wide variety of cameras such as a fish-eye camera, a wide-angle camera, a webcam etc. The camera 202 may also be configured to capture a 360 degrees view of its surroundings. It is to be noted that the selection of the camera 202 is not limited to the above mentioned cameras. The camera 202 may be any state-of-art camera that satisfies the purpose of the invention.

Further, the camera support 204 may be any support that is able to hold the camera 202 such that the camera 202 is able to function in a stable manner and in order to prevent the camera from shaking or moving while it captures an image or a video. The camera support 204 may be a plastic support, a metal support, a wooden support or may be made up of any suitable material. The camera 202 may be fixed on one end of the camera support 204 or any other suitable position on the camera support 204 such as the camera 202 being held by a clip attached to the camera support 204. The camera 202 may be installed on the support in any position such that the camera 202 is able to capture the electronic device 206 or any object (not shown) placed on the electronic device 206. The camera support 204 may be installed perpendicular to or at any angle to a plane of the electronic device 206. The camera support 204 may further be attached to the electronic device 206 or it may be detached from the electronic device 206, for example supported by a structure such as a wall or a ceiling, supported by another person such as another camera or mobile device supported by a friend, or supported by the user's clothing as depicted by the embodiments shown in FIGS. 2(a) and 2(b), respectively.

FIG. 2(a) represents an embodiment of the invention in which the camera support 204 is attached to the electronic device 206. The camera support 204 may be perpendicular to or inclined (now shown) at a predetermined angle to the plane of the electronic device 206. In accordance with the embodiment of the invention, the support may hold the camera 202 at a predetermined height from the plane of the electronic device 206 in order to facilitate image or video capturing by the camera 202.

FIG. 2(b) represents another embodiment of the invention in which the camera support 204 is not attached to the electronic device 206. In accordance with the embodiment of the invention, the camera support 204 along with the camera 202 may be placed at a predetermined distance from the electronic device 206. Examples of the embodiment may include placing the camera support 204 and the camera 202 on a user's hat, a mobile phone or a laptop, an arm rest of a chair etc. It is to be noted, however, that the camera support 204 and the camera 202 can be placed at any other place not limited to the above mentioned examples.

FIG. 3 is a block diagram of internal components of an electronic device 306, a remote touch receiver 320, and a remote display 326 in accordance with an embodiment of the invention. The electronic device 306 may correspond to the electronic device 106 of FIG. 1 and the electronic device 206 of FIG. 2. The receiver 320 may be a part of the display screen 110 as shown in FIG. 1.

The block diagram 300 of the electronic device 306 and the receiver unit 320 includes various components. The internal components of the electronic device 306 may include a touch module 302, a processor 304, a display unit 308, a transceiver unit 310, and a memory 312 that may optionally include a video memory 314. The touch module 302 may register touch inputs provided by an object such as the object 108 of FIG. 1 on the electronic device 306. The touch module 302 may be coupled to a processor 304 and may provide the registered touch inputs to the processor 304 for further processing. The electronic device 306 may further include a display unit 308 is coupled to the processor 304. The display unit 308 may include a touch-sensitive display. Examples of the display unit 308 may include may include one or more of the following components: a cathode ray tube, a liquid crystal display, a plasma display, or a front or rear projection display etc. The display unit 308 may display various images or objects, such as a set of icons, a game, a set of icons, a video, or a still image. The display unit 308 may also be coupled to the processor 304.

The electronic device 306 may further include one or more transceivers in the transceiver unit 310 that may be capable of receiving signals from multiple antennas and from various devices or networks. The electronic device 306 may further include a memory 312 that may be coupled to the processor 304. The memory 312 may store data and instructions for the operation of the processor 304. In one embodiment, the memory 312 includes buffers for storing data. In another embodiment, the memory 312 may include a video memory 314 for storing real-time data in the form of images and videos captured by the camera 202 of the FIG. 2. In the various embodiments, the memory 312 may be one or more separate components and/or may be partitioned in various ways for various purposes such as but not limited to, optimizing memory allocations, etc. Thus it is to be understood that the exemplary memory 312 illustrated in FIG. 3 is for illustrative purposes only, for the purpose of explaining and assisting one of ordinary skill in understanding the various embodiments described herein.

Further, the processor 304 may be coupled to the transceiver unit 310, the memory 312, and the display unit 308. However, it is to be understood that one or more of these components may be combined or integrated in a common component, or a components features may be distributed among multiple components. Also, the components of the electronic device 306 may be connected differently, such as bypassing the processor 304, without departing from the scope of the invention. The processor 304 operates in conjunction with the data and instructions stored in the memory 312 to control the operation of the electronic device 306. The processor 304 may be implemented as a digital signal processor, a hard-wired logic and analog circuitry, or any suitable combination of these.

Further, the electronic device 306 may communicate with a remote touch receiver 320. The communication between the electronic device 306 and the remote touch receiver 320 may be via a wireless connection 316 or a wired connection 318.

In further accordance with the embodiment of the invention, the remote touch receiver 320 may comprise various internal components such as a hand overlay unit 322 and a multi-touch driver 324, which may be required for the functioning of the remote touch receiver 320. The hand overlay unit 322 may be configured to superimpose an image of the object 108 of FIG. 1 received from the electronic device 306 on another image that is displayed at the surface of the electronic device 306. It is to be noted, however, that the superimposing by the hand overlay unit 322 is not limited to the superimposing of images. It can also include superimposing of any type of visual real-time content e.g. superimposing of real-time video that may subsequently, be presented to a user. In accordance with the embodiment of the invention, the multi-touch driver 324 may be configured to translate touch events provided by the electronic device 306 and further, provide the touch events to a display screen 326 such as the display screen 110 of FIG. 1 for synchronizing the touch events with the superimposed content to be displayed by the display screen 110.

Further, the display screen 326 may include one or more of the following components: a cathode ray tube, a liquid crystal display, a plasma display, or a front or rear projection display etc. The display screen 326 may display various images or objects, such as a set of icons, a game, a set of icons, a video, or a still image.

In accordance with an embodiment of the invention, a camera 202 captures a real-time image or a real-time video of the object 108 placed over the electronic device 106 of FIG. 1. A real-time stream may be produced from the real-time content captured by the camera 202. In further accordance with the embodiment of the invention, a user can provide touch inputs to the electronic device 106 of FIG. 1 by touching a touch-sensitive portion of the electronic device 106. The touch inputs provided by the user may be registered as touch events by the electronic device 106. Further, the electronic device 106 may also display content, e.g. images or video etc. at the surface of the electronic device 106.

In further accordance with the embodiment of the invention, the electronic device 106 may provide the content displayed on its surface, the touch events, and the real-time image of the object 108 placed over the electronic device 106 captured by the camera 202 to the remote touch receiver 320. The hand overlay unit 322 of the remote touch receiver 320 may receive the real-time image captured by the camera 202 and the content displayed at the surface of the electronic device 106. The hand overlay unit 322 may subsequently, superimpose the real-time image captured by the camera 202 over the content displayed at the surface of the electronic device 106. In accordance with some embodiments of the invention, the superimposing may comprise overlaying the real-time image captured by the camera 202 over the content displayed at the surface of the electronic device 106 to generate a superimposed content. Further, superimposing may also comprise positioning or placing the real-time image captured by the camera 202 over the content displayed at the surface of the electronic device 106 such that at least a portion of the content displayed at the surface of the electronic device 106 is overshadowed by at least a portion of the real-time image captured by the camera 202.

Further, a multi-touch driver unit 324 of the remote touch receiver 320 may receive the touch events from the electronic device 106. The multi-touch driver unit 324 may further synchronize the touch events with the superimposed content produced by the hand overlay unit 322. Further, the synchronized touch events and the superimposed content are provided by the remote touch receiver 320 to a remote display 326. It is to be noted that the remote touch receiver 320 and the display screen 326 may be components of a same entity such as the display screen 110 of FIG. 1 or may reside remotely from each other. Further, the remote touch receiver 320 and the display screen 326 are remotely situated from the electronic device 106.

In an example, if a game is being played on the electronic device 106, the game is displayed at the surface of the electronic device 106 by the display unit 308 of the electronic device such as the display unit 308 of FIG. 3. The user provides inputs by touching the surface of the touch pad 106. The touch inputs may be registered as touch events by the touch module 302 and provided to the processor 304 for further processing. A real-time image or video may be captured by the camera 202. The captured real-time image may represent a view comprising the user's hands placed on the electronic device 106 and their surroundings. The electronic device 106 may provide the real-time image captured by the camera 202, the touch events, and the content displayed at the surface of the electronic device 106 to the remote touch receiver 320. The remote touch receiver 320 may further, superimpose the real-time image captured by the camera 202 over the content displayed at the surface of the electronic device 106 to produce a superimposed content. The superimposed content may further be provided to a display screen 326 to be presented to the user. Such a display would enable the user to experience a real-time view, on the display screen 326, of his hands placed on the electronic device 416.

The invention thus, enables the user to view a real-time image or video on the remote display and simultaneously provide inputs while looking at the display screen 326 without looking at the remote electronic device 106. The display screen 326 presents an actual and real-time view of the object 108 placed on the electronic device 106, which is similar to what the user would view if he viewed the content displayed on the electronic device 106.

Moreover, it is to be understood that FIG. 3 is provided merely for the purpose of illustrating the principles of the present invention. FIG. 3 is not intended to be a comprehensive perspective view of all of the components of such a communication system. Therefore, the system 300 may comprise various other configurations and still be within the scope of the present disclosure.

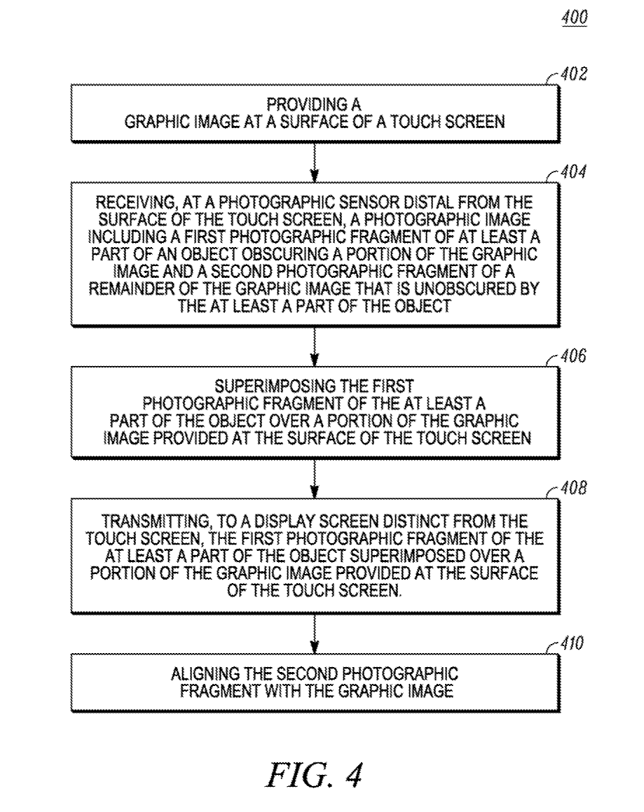

FIG. 4 is a flowchart of a first method in accordance with some embodiments of the invention. Referring to FIG. 4, the method 400 begins with a step of providing 402 a graphic image at a surface of the electronic device 106 of FIG. 1. The graphic image may be displayed at the surface of the electronic device 106. In one example, the electronic device 106 is able to display an image, a video, or a set of icons etc. The graphic image may comprise any content displayed on the surface of the electronic device 106 such as an image, a real-time or a non-real time video, a game, or a set of icons etc.

The method 400 further comprises receiving 404 at a photographic sensor e.g. camera 202 of FIG. 2, distal from the surface of the electronic device 106, a photographic image including a first photographic fragment of a part of the object 108 obscuring a portion of the graphic image and a second photographic fragment of a remainder of the graphic image that is unobscured by the part of the object 108. The camera 202 may capture a view of the object 108 of FIG. 1 that obscures a part of the graphic image displayed on the surface of the electronic device 106. In one example, the graphic image may comprise an image of the game displayed on the surface of the electronic device 106. A part of the graphic image may be obscured by the object 108 of FIG. 1 when the object 108 is placed over the graphic image. The camera 202 may also capture the remaining portion of the graphic image that is not obscured by the object 108. The photographic image including the first photographic fragment and the second photographic fragment is provided to the remote touch receiver 320.

The method 400 further comprises superimposing 406 the first photographic fragment of the part of the object 108 over a portion of the graphic image provided at the surface of the electronic device 106. The superimposing may be performed by the hand overlay unit 322 of FIG. 3. The hand overlay unit 322 may perform the superimposing by overlaying the first photographic fragment of the part of the object over the graphic image provided at the surface of the electronic device 106. In one example, the first photographic fragment may comprise an image of a user's hands placed over the electronic device 106. In another example, the first photographic fragment may also comprise an image of a stylus placed over the electronic device 106. In still another example, the graphic image may comprise a set of icons displayed on the surface of the electronic device 106. In yet another example, the graphic image may comprise an image of the game as displayed on the surface of the electronic device 106. The first photographic fragment may be superimposed over a portion of the graphic image in such a way that the first photographic fragment obscures the portion of the graphic image over which, the first photographic fragment is superimposed to produce a superimposed content.

The method 400 further comprises a step of transmitting 408 to a display screen distinct from the electronic device 106, the first photographic fragment of the part of the object 108 superimposed over a portion of the graphic image provided at the surface of the electronic device 106. The transmitting may be performed by the remote touch receiver 320 of FIG. 3. The remote touch receiver 320, after performing the superimposing 406, may transmit the superimposed content to a display screen 326 of FIG. 3 for presenting the superimposed content to the user. The remote touch receiver 320 may also synchronize the touch events and transmit the synchronized touch events along with the superimposed content to the remote display 326.

The method 400 further comprises aligning 410 the second photographic fragment with the graphic image. The aligning may be performed by the remote touch receiver 320 of FIG. 4. In accordance with one embodiment of the invention, the aligning 410 may comprise synchronizing the second photographic fragment of a remainder of the graphic image that is unobscured by the part of the object 108 with the first photographic fragment of the part of the object 108. In accordance with the embodiment of the invention, the first and the second photographic fragment may comprise still images. In accordance with another embodiment of the invention, the first photographic fragment and the second photographic fragment may be part of a video stream. In accordance with the embodiment of the invention, the synchronization may be performed on a frame-by-frame basis i.e., each frame of the second photographic fragment may be aligned with a corresponding frame of the first photographic fragment.

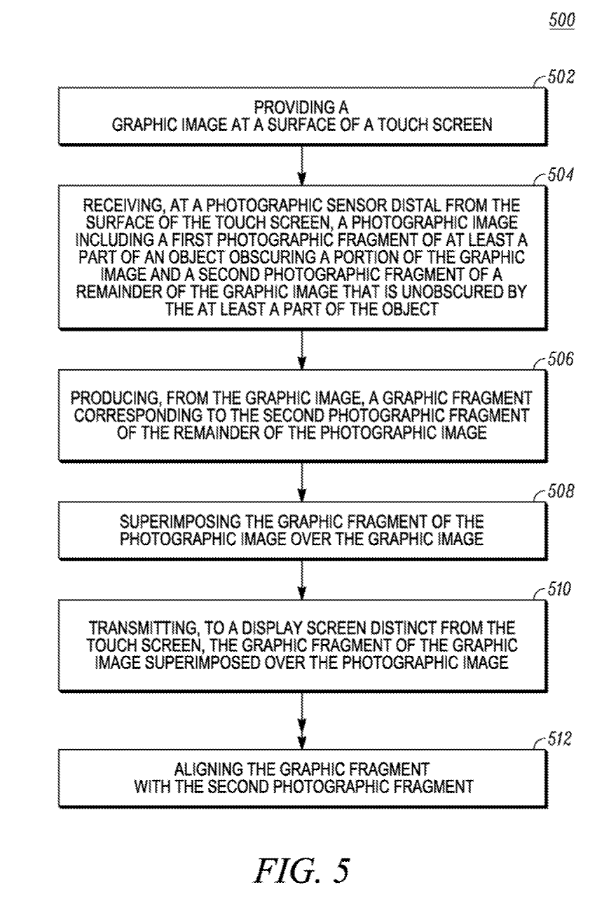

FIG. 5 is a flowchart of a second method in accordance with some embodiments of the invention. Referring to FIG. 5, the method 500 begins with a step of providing 502 a graphic image at a surface of an electronic device 106. As discussed in the context of FIG. 5, the graphic image may be displayed at the surface of the electronic device 106 of FIG. 1. In one example, the electronic device 106 is able to display an image, a video, or a set of icons etc. The graphic image may comprise any content displayed on the surface of the electronic device 106 such as an image, a real-time or a non-real time video, a game or a set of icons etc.

The method 500 further comprises receiving 504, at a photographic sensor e.g. camera 202 of FIG. 2, distal from the surface of the electronic device 106, a photographic image including a first photographic fragment of at least a part of an object 108 obscuring a portion of the graphic image and a second photographic fragment of a remainder of the graphic image that is unobscured by the at least a part of the object. In one example, the photographic sensor may be camera 202 of FIG. 2. The camera 202 may capture a view of an object 108 of FIG. 1 that obscures at least a part of a graphic image displayed on the surface of the electronic device 106. In one example, the graphic image may comprise an image of the game displayed on the surface of the electronic device 106. A part of the graphic image may be obscured by the object 108 of FIG. 1 when the object 108 is placed over the graphic image. The camera 202 may also capture the remaining portion of the graphic image that is not obscured by the object 108. The photographic image including the first photographic fragment and the second photographic fragment is provided to the remote touch receiver 320.

The method 500 further comprises a step of producing 506 from the graphic image, a graphic fragment corresponding to the second photographic fragment of the remainder of the photographic image. The producing may be performed by the remote touch receiver 320 of FIG. 4. In accordance with an embodiment of the invention, the producing may comprise extracting from the graphic image, the second photographic fragment that comprises the portion of the graphic image that is not obscured by the object 108 of FIG. 1.

The method 500 further comprises a step of superimposing 508 the graphic fragment of the photographic image over the graphic image. The superimposing may be performed by the hand overlay unit 322 of FIG. 3. The hand overlay unit 322 may perform the superimposing by overlaying the graphic fragment of the photographic image over the graphic image to produce a superimposed content.

In one example, the photographic image may comprise an image captured by the camera 202 of FIG. 2. The photographic image comprises a first photographic fragment that represents the object 108 i.e., the user's hands placed over the electronic device 106 and a second photographic fragment that represents a portion the image of the game that is not obscured by the user's hands. The graphic fragment corresponding to the second photographic fragment is extracted from the photographic image and subsequently, superimposed over a graphic image i.e., the image of the game that is displayed at the surface of the electronic device 106.

The method 500 further comprises a step of transmitting 510, to a display screen distinct from the electronic device 106, the graphic fragment of the graphic image superimposed over the photographic image. The transmitting may be performed by the remote touch receiver 320 of FIG. 4. The remote touch receiver, after performing the superimposing 508, may transmit the superimposed content to a remote display 326 of FIG. 1 for presenting the superimposed content to the user. The remote touch receiver 320 may also synchronize the touch events and transmit the synchronized touch events along with the superimposed content to the remote display 326.

The method 500 further comprises aligning 512 the graphic fragment with the second photographic fragment. The aligning may be performed by the remote touch receiver 320 of FIG. 3. In accordance with one embodiment of the invention, the aligning 510 may comprise synchronizing the graphic fragment with the second photographic fragment. In accordance with the embodiment, the graphic fragment and the second photographic fragment may comprise still images. In accordance with another embodiment of the invention, the graphic fragment and the second photographic fragment may be part of a video stream. In accordance with the embodiment of the invention, the synchronization may be performed on a frame-by-frame basis i.e., each frame of the second photographic fragment may be aligned with a corresponding frame of the graphic fragment.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of an electronic device for managing displayed content, the method comprising:
providing a graphic image at a surface of a touch screen;
receiving, at a photographic sensor distal from the surface of the touch screen, a photographic image including a first photographic fragment of at least a part of an object obscuring a portion of the graphic image and a second photographic fragment of a remainder of the graphic image that is unobscured by the at least a part of the object; and
transmitting, to a display screen distinct from the touch screen, the first photographic fragment of the at least a part of the object superimposed over a portion of the graphic image provided at the surface of the touch screen.

2. The method of claim 1, wherein transmitting the first photographic fragment of the at least a part of the object superimposed over the graphic image provided at the surface of the touch screen includes aligning the second photographic fragment with the graphic image.

3. The method of claim 1, wherein receiving the photographic image includes receiving a photographic video image.

4. The method of claim 1, wherein the display screen is remotely located from the touch screen.

5. The method of claim 1, wherein the photographic sensor is located at a fixed distance from the surface of the touch screen.

6. The method of claim 1, wherein the object comprises at least one of at least a part of a user's hand or at least a part of a stylus.

7. The method of claim 1, wherein the display screen is connected to the touch screen via a wireless or wired connection.

8. The method of claim 1, wherein the touch screen comprises at least one of a tablet, a touch screen device, a personal digital assistant, a handheld device, a portable computing device, a game controller, or a wireless communication device.

9. A method of an electronic device for managing displayed content, the method comprising:
providing a graphic image at a surface of a touch screen;
receiving, at a photographic sensor distal from the surface of the touch screen, a photographic image including a first photographic fragment of at least a part of an object obscuring a portion of the graphic image and a second photographic fragment of a remainder of the graphic image that is unobscured by the at least a part of the object;
producing, from the graphic image, a graphic fragment corresponding to the second photographic fragment of the remainder of the photographic image; and
transmitting, to a display screen distinct from the touch screen, the graphic fragment of the graphic image superimposed over the photographic image.

10. The method of claim 9, wherein transmitting the graphic fragment of the graphic image superimposed over the photographic image includes aligning the graphic fragment with the second photographic fragment.

11. The method of claim 9, wherein receiving the photographic image includes receiving a photographic video image.

12. The method of claim 9, wherein the display screen is remotely located from the touch screen.

13. The method of claim 9, wherein the photographic sensor is located at a fixed distance from the surface of the touch screen.

14. The method of claim 9, wherein the object comprises at least one of at least a part of a user's hand or at least a part of a stylus.

15. The method of claim 9, wherein the display screen is connected to the touch screen via a wireless or wired connection.

16. The method of claim 9, wherein the touch screen comprises at least one of a tablet, a touch screen device, a personal digital assistant, a handheld device, a portable computing device, a game controller, or a wireless communication device.

17. An electronic device for managing content, comprising:
a touch screen configured to display a graphic image at a surface of the touch screen;
a photographic sensor, distal from the surface of the touch screen, configured to receive a photographic image including a first photographic fragment of at least a part of an object obscuring a portion of the graphic image and a second photographic fragment of a remainder of the photographic image that is unobscured by the at least a part of the object; and
a transmitter configured to transmit, to a display screen distinct from the touch screen, the first photographic fragment of the at least a part of the object superimposed over a portion of the graphic image provided at the surface of the touch screen.

18. The electronic device of claim 17, wherein the display screen is remotely located from the touch screen.

19. The electronic device of claim 17, wherein the photographic sensor is located at a fixed distance from the surface of the touch screen.

20. The electronic device of claim 17, wherein the display screen is connected to the touch screen via a wireless or wired connection.
